(19) United States
(12) Patent Application Publication
(10) Pub. No.: US 2025/0009167 A1
(43) Pub. Date: Jan. 9, 2025

(54) BOTTLE HEATING APPARATUS

(71) Applicant: VTech Telecommunications Limited, Hong Kong (CN)

(72) Inventors: L.H. Yang, Shenzhen (CN); Chen Sun, Shenzhen (CN)

(21) Appl. No.: 18/348,982

(22) Filed: Jul. 7, 2023

(51) Int. Cl. A47J 36/24

(52) U.S. Cl. CPC A47J 36/2433; A47J 2202/00

(57) ABSTRACT

Provided are bottle heating apparatuses for heating the contents of a bottle. In embodiments, a bottle heating apparatus comprises a housing with a chamber for receiving a bottle and at least one ultrasonic transducer disposed within the chamber and configured to heat a substance within the bottle with an ultrasonic energy when the bottle is positioned in the chamber. In embodiments, the ultrasonic transducer is positioned to direct the ultrasonic energy toward the center axis of the bottle at an angle, for example, between 10 and 60 degrees, wherein the angle is relative to a plane perpendicular to the center axis of the bottle when the bottle is positioned in the chamber and the angle is defined as positive in a direction from which the bottle is received by the chamber.

### FIELD OF THE INVENTION

The present disclosure relates generally to bottle heating apparatuses.

### BACKGROUND OF THE INVENTION

There is a common need to heat contents of bottles, such as thawing or heating milk or baby formula in a baby bottle. Microwave heating is not recommended for such bottle contents. Users thus need a safe non-microwave means for quickly, efficiently, thoroughly, and accurately heating bottles with such contents.

### BRIEF DESCRIPTION OF THE DRAWINGS

FIG. 1 is a perspective view of an exemplary bottle heating apparatus.

FIG. 2 is a top view of the exemplary bottle heating apparatus.

FIG. 3 is a front view of the exemplary bottle heating apparatus.

FIG. 4 is a back view of the exemplary bottle heating apparatus.

FIG. 5 is a sectional view of the exemplary bottle heating apparatus taken upon plane A as shown in FIG. 2.

FIG. 6 is a side view of the exemplary bottle heating apparatus.

FIG. 7 is a sectional view of the exemplary bottle heating apparatus taken upon plane B as shown in FIG. 2.

### DETAILED DESCRIPTION

The following disclosure provides different embodiments, or examples, for implementing different features of the subject matter. Specific examples of components, features, arrangements, or steps are described below to simplify the present disclosure. These are, of course, merely examples and are not intended to be limiting.

Disclosed embodiments are directed to a bottle heating apparatus (the term “heating,” as used herein, comprises thawing). The apparatus can comprise a housing with a chamber for receiving a bottle, or portion thereof, and one or more ultrasonic transducers optimally positioned and angled to heat the contents of the bottle. The apparatus can also comprise an infrared temperature sensor for sensing the temperature of contents of the bottle. In embodiments, the bottle can be a baby bottle and the contents of the bottle can be milk (e.g., breast milk) or baby formula.

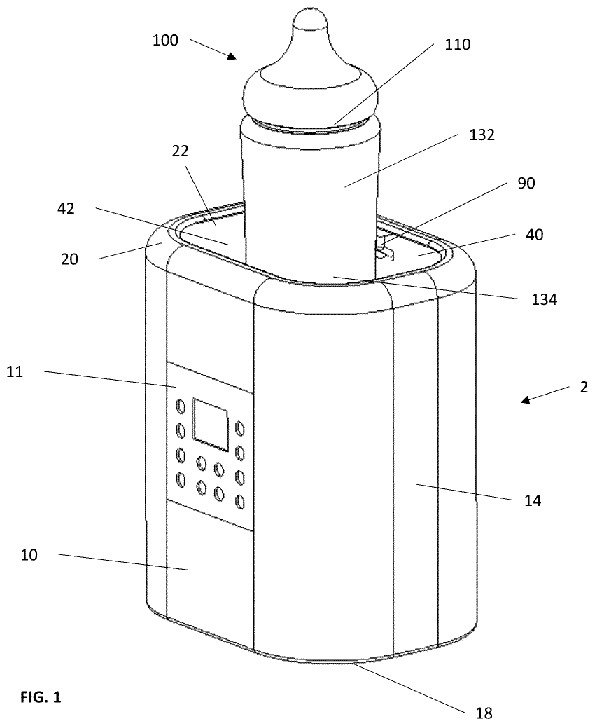

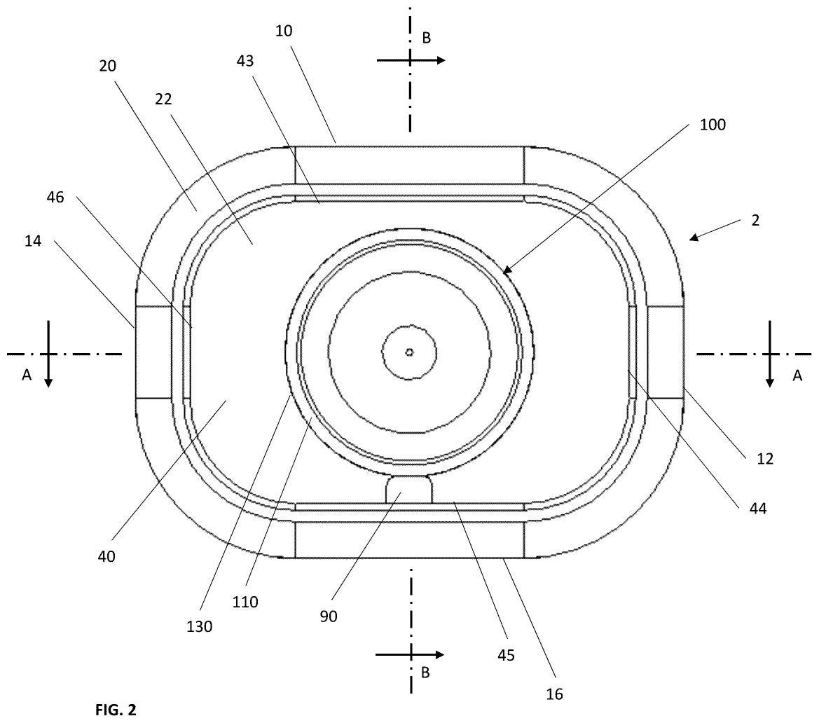

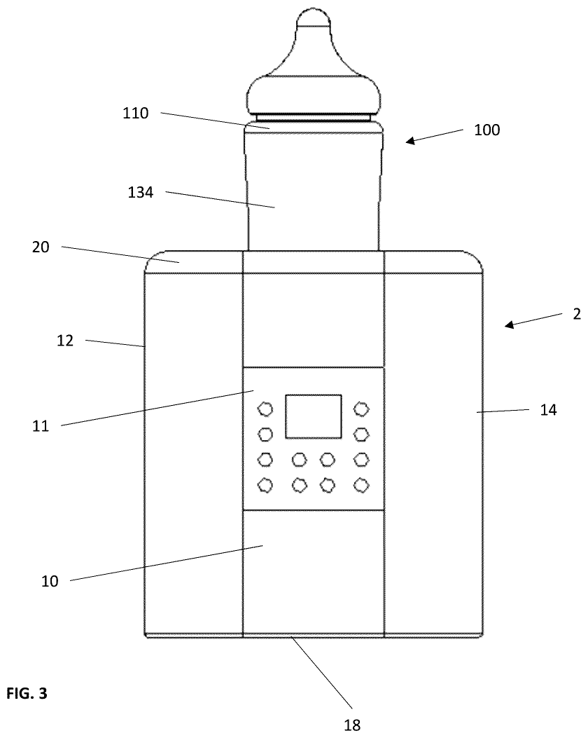

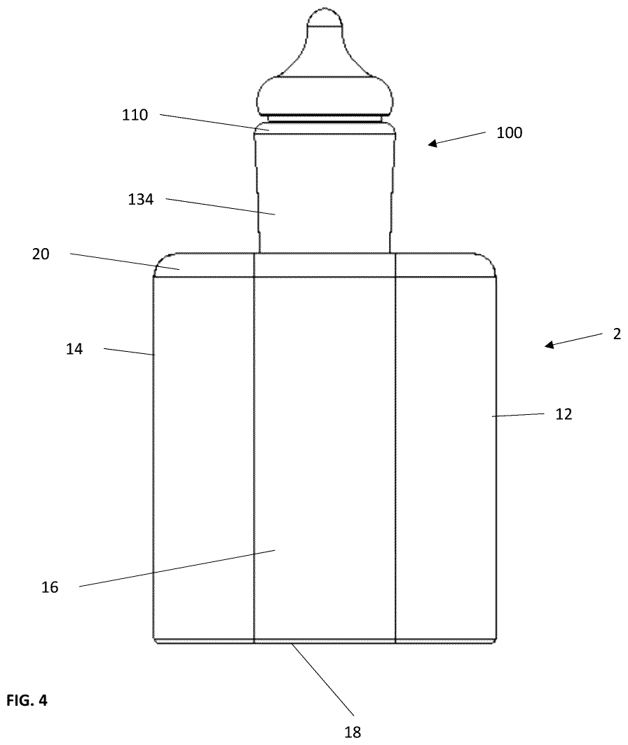

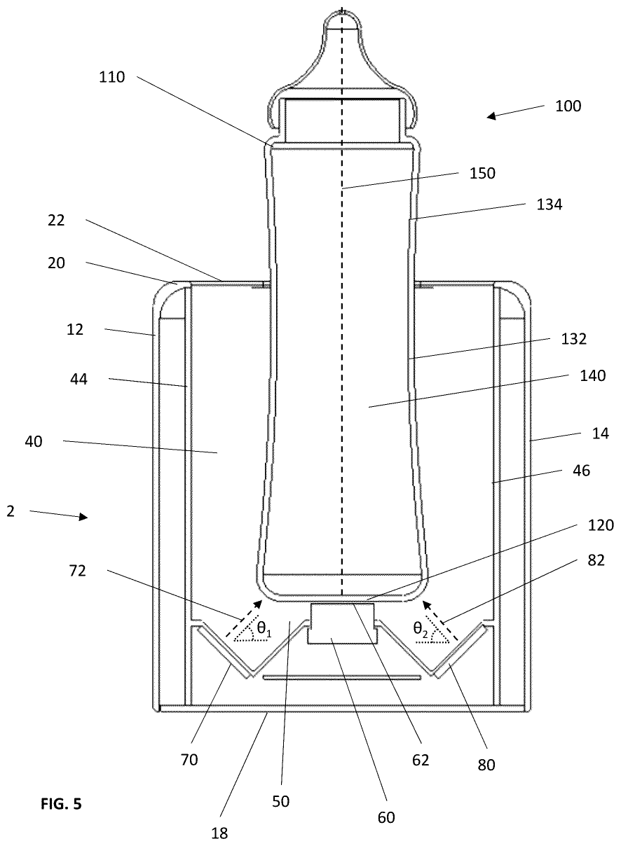

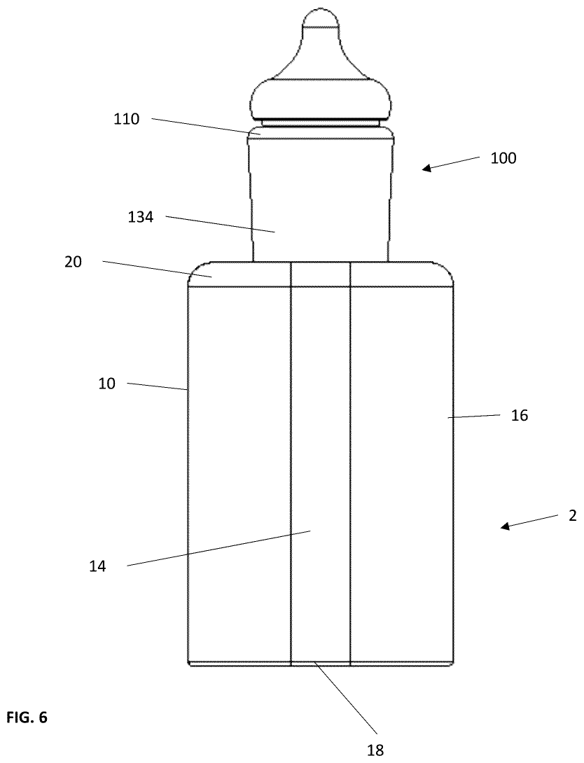

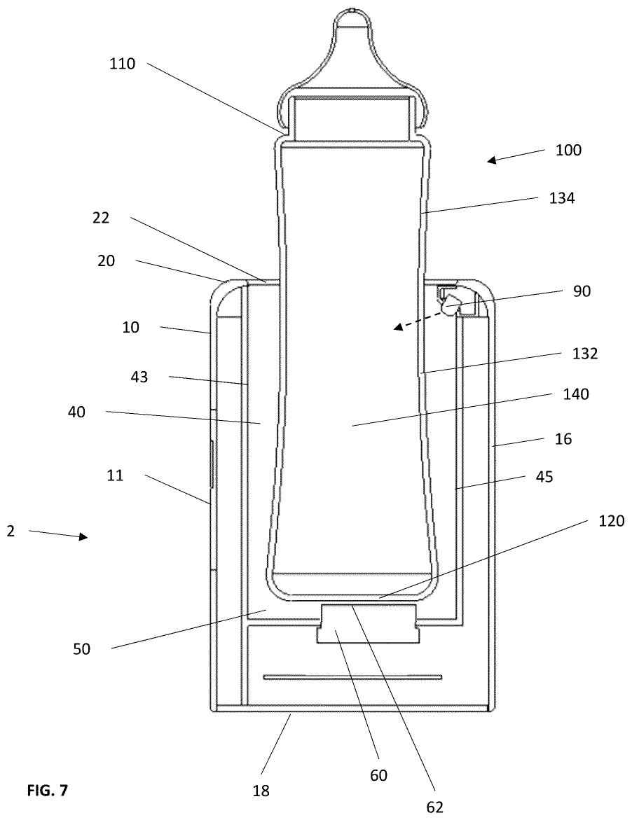

FIGS. 1-7 are various views of an exemplary bottle heating apparatus, comprising a housing 2 for heating a bottle 100. FIG. 1 is a perspective view of the exemplary bottle heating apparatus, and FIGS. 2, 3, 4, and 6 are top, front, back, and side views, respective, of the exemplary bottle heating apparatus. FIGS. 5 and 7 are sectional views taken along planes A and B, respectively, as shown in FIG. 2.

The housing can comprise a base, exterior side(s), and top and can comprise an opening for receiving one or more bottles. The opening, for example, can be an opening in the top, side, and/or top edge of the housing.

The housing can comprise a chamber, and the chamber can extend from the opening. For example, the chamber can extend down from an opening at or near the top of the housing, can extend laterally or at a downward angle from an opening at or near a side of the housing, or can extend at a downward angle from an opening at or near a top edge of the housing. In embodiments, the chamber is defined by the opening; one or more chamber walls opposite of the opening, which can be, for example, a bottom wall or portion; and one or more chamber walls extending from the opening to the bottom portion, which can be, for example, one or more side walls or a side wall with multiple sides or segments. In embodiments, the chamber is insulated, such as with insulation behind the chamber walls.

A bottle or portion thereof can be inserted through the opening into the chamber. For example, the bottle can be inserted base first in a linear direction that is substantially parallel to the center axis of the bottle extending through the center of the base of the bottle and the center of the top of the bottle.

In embodiments, the bottle is held in position within the chamber by resting on a wall (e.g., bottom wall) or component (e.g., heating component such as a heating element or ultrasonic transducer). In embodiments, the bottle is held in position within the chamber by one or more components configured to hold the bottle suspended in the chamber, such as one or more projecting members, juts, hooks, slots, or similar or equivalent component. In embodiments, the bottle is stationary when in position within the chamber. In embodiments, the bottle is non-stationary when being heated within the chamber. For example, the bottle can be rotated, moved up and down, moved side to side, vibrated, swirled, or otherwise moved or agitated when being heated within the chamber. Such movement can, for example, improve heating of the contents of the bottle such as by facilitating convection within the contents of the bottle. In embodiments, the bottle can be moved by one or more moving components within the housing. In embodiments, heating components, such as heating elements and ultrasonic transducers, can be moved along with the bottle, such as to maintain the spatial relationship and/or contact between the bottle and heating components during movement of the bottle.

The system can be compatible with bottles of any materials, including glass or various types of plastic. The apparatus can be configured to heat a bottle with a bath (e.g., water bath), without a bath, or both.

In embodiments, when a bottle is in position within the chamber (i.e., ready for heating), the bottle completely within the chamber. In embodiments, when a bottle is in position within the chamber, the bottle is only partially within the chamber. In embodiments, when the bottle is in position within the chamber, at least 50%, 60%, 70%, 80%, or 90% of the bottle, based on height from the base of the bottle to the top of the bottle, is within the chamber when the bottle is in position within the chamber. In embodiments, the apparatus can comprise a lid or flexible covering to cover the opening and/or enclose the chamber when a bottle is in position within the chamber. In embodiments, the lid or flexible covering is configured to allow a bottle to protrude through the lid or flexible covering when the bottle is in position within the chamber and the lid or flexible covering is in place to enclose the chamber.

The bottle heating apparatus shown in FIGS. 1-7 comprises a housing 2, the exterior of which comprises a front exterior side 10, first exterior side 12, second exterior side 14, back exterior side 16, base 18, and top side 20. A control panel 11 is included on front exterior side 10, for example, for controlling operation of housing 2. An opening 22 is formed in top side 20 and provides access to a chamber 40 formed in housing 2. Chamber 40 comprises a bottom portion 50, which is on the opposite side of chamber 40 as opening 22, and interior wall 42, which comprises a first side 43, second side 44, third side 45, and fourth side 46. Chamber 40 is defined by opening 22, bottom portion 50, and interior wall 42. Housing 2 and chamber 40 are shown as rectangular shaped with rounded corners. In other embodiments, the housing and/or chamber can have alternative shapes and designs, including a cylinder shape or cylindrical shape. In other embodiments, opening 22 can be formed in an exterior side of housing 2, such as front exterior side 10, first exterior side 12, second exterior side 14, or back exterior side 16, and chamber 40 can extend from opening 22 laterally, or laterally and downward, into housing 2, such that bottle 100 would be inserted into, and in position within, chamber 40 in a sideways position or angled position compared to vertically as shown in FIGS. 1-7. In other embodiments, opening 22 can be formed in a top edge or top side of housing 2, and chamber 40 can extend from opening 22 laterally and downward into housing 2, such that bottle 100 would be inserted into, and in position within, chamber 40 in an angled position compared to vertically as shown in FIGS. 1-7. The description of positioning and angling herein would be reinterpreted accordingly, depending on the location of opening 22 in housing 2 and how the chamber 40 extends into housing 2 and bottle 100 is positioned within chamber 40.

The opening 22 and chamber 40 of housing 2 are configured to receive a bottle, such as exemplary bottle 100, for heating. Bottle 100 comprises a top portion 110, to which a nipple can be secured. Bottle 100 also comprises a base 120 and side 130. Bottle 100 comprises a bottle interior 140, which can contain and store contents such as milk, water, baby formula, and/or other substances or materials. A center axis 150 of bottle 100 extends through the center of top portion 110, base 120, and bottle interior 140.

FIGS. 1-7 show bottle 100 in position and ready for heating within chamber 40. Bottle 100 is stable and stationary in this position, with the base 120 of bottle 100 resting on a top surface 62 of heating plate 60. In embodiments, bottle 100 can be, for example, rotated when bottle 100 is in position within chamber 40, such as by rotation of heating plate 60 on which bottle 100 rests. When bottle 100 is in position within chamber 40, as shown, bottle 100 is only partially within chamber 40, such that side 130 of bottle 100 comprises an enclosed portion 132 that is within chamber 40 and a non-enclosed portion 134 that is outside of chamber 40. Opening 22 and chamber 40 are sized to receive and be compatible with bottles of various shapes and sizes, including 2 oz. bottles to 9 oz. bottles and larger.

In embodiments, the housing includes one or more heating elements configured to heat the bottle and its contents via thermal conduction, convection, or radiation. For example, a heating element can be an electric heating element. For example, a heating element can be a heating plate, heating coil (e.g., electric coil), or heat lamp.

A heating element can be disposed within the chamber. For example, a heating element can be positioned in a bottom portion of the chamber or positioned at or along an interior wall of the chamber, such as a bottom wall or side wall of the chamber. In embodiments, when a bottle is in position within the chamber, a portion of the bottle rests on a heating element, in physical contact with the heating element. For example, a base of the bottle can rest on a heating element at the bottom portion of the chamber. For example, a side of the bottle can rest against a heating element along a side wall of the chamber. In embodiments, when a bottle is in position within the chamber, a portion of the bottle is proximate to but not in physical contact with a heating element. For example, a base of the bottle can be suspended proximate to a heating element at the bottom portion of the chamber. For example, a side of the bottle can be suspended proximate to a heating element along a side wall of the chamber.

As shown in FIGS. 5 and 7, housing 2 comprises a heating element in the form of a heating plate 60 positioned in the bottom portion 50 of chamber 40, and exemplary bottle 100 is configured to rest on top of and be in physical contact with a top surface 62 of heating plate 60 when bottle 100 is in position within chamber 40. Heating plate 60 heats the base 120 of bottle 100 and thus heats bottle interior 140 and any contents therein.

In embodiments, the housing includes one or more ultrasonic transducers configured to heat the bottle and its contents via ultrasonic energy. In embodiments, the ultrasonic transducers heat the bottle and its contents directly, and in embodiments, the ultrasonic transducers heat the bottle and its contents indirectly via a bath.

For liquids and gases, a method for quickly transferring heat is through convection. Ultrasonic devices, along with other heating elements, can accelerate convection through resonance and thermodynamic principles, achieving the goal of rapid thawing and heating. Ultrasonic waves are sound waves with frequencies higher than 20000 Hz, called ultrasonic waves. One related heating principle is resonance. When the frequency of an ultrasonic wave is the same as the natural frequency of a molecule that makes up a material, it will cause the resonance of the molecule, which will greatly increase the vibration amplitude of the molecule. The increase in the amplitude of the molecular vibrations will collide with other molecules similar to it, thus increasing the intensity of the irregular movement of a large number of molecules in the whole material body, and rapidly increasing the temperature. Another related heating principle is thermodynamics. The essence of temperature is a physical quantity that measures the intensity of the irregular movement of a large number of molecules within a constant substance, only appearing as cold or hot on the surface. The stronger the molecular motion, the higher the temperature. Another consideration is cavitation. When ultrasonic waves propagate in a liquid, small cavities are created inside the liquid due to the intense vibration of liquid particles. These small cavities rapidly expand and close, causing violent collisions between liquid particles, resulting in pressures of thousands to tens of thousands of atmospheres. The intense interaction between particles can cause a sudden increase in the temperature of the liquid, providing a good stirring effect, thereby emulsifying two immiscible liquids (such as water and milk powder), accelerating the dissolution of solutes, and accelerating chemical reactions. The cavitation effect of ultrasound is the various effects caused by the action of ultrasound in liquids.

Compared to traditional electric heating methods for bottle contents, ultrasonic heating has a stronger directionality and is more capable of centralized heating. The number, positioning, and angling of one or more ultrasonic transducers, together with other aspects of the embodiments described herein, provides for faster, more efficient heating of contents in a bottle.

An ultrasonic transducer can be disposed within the chamber. In one example, an ultrasonic transducer physically contacts the bottle when the bottle is in position within the chamber. In one example, an ultrasonic transducer is proximate to the bottle when the bottle is in position within the chamber. In one example, an ultrasonic transducer selectively does or does not physically contact the bottle when the bottle is in position within the chamber, for example, based on a user control, heating profile, automatic sensing of a bottle positioned within the chamber, or setting.

In embodiments, an ultrasonic transducer can be positioned on or in an interior wall of the chamber such as a bottom or side wall. In one example, an ultrasonic transducer is positioned along a side wall of the chamber. For example, an ultrasonic transducer can be positioned on or in the side wall at a position that is in the bottom 50%, 40%, 30%, 20%, or 10% of the side wall as measured by the height of the side wall from the end of the chamber opposite to the opening (e.g., bottom wall of the chamber) to the opening. For example, an ultrasonic transducer can be positioned on or in the side wall at a position that is in the top 50%, 40%, 30%, 20%, or 10% of the side wall as measured by the height of the side wall from the end of the chamber opposite to the opening (e.g., bottom wall of the chamber) to the opening. For example, an ultrasonic transducer can be positioned on or in the side wall at a position that is in the middle of the side wall or the middle 50%, 40%, 30%, 20%, or 10% of the side wall as measured by the height of the side wall from the end of the chamber opposite to the opening (e.g., bottom wall of the chamber) to the opening.

In embodiments, an ultrasonic transducer can be positioned relative to the bottom or side of a bottle positioned in the chamber. For example, an ultrasonic transducer can be positioned such that it is in contact with, proximate to, or directed at a particular portion of the bottle when the bottle is in position within the chamber, such as the base of the bottle, the side of the bottle, or the edge between the base and side of the bottle. For example, an ultrasonic transducer can be positioned such that it is in contact with, proximate to, or directed at a particular portion of the side of the bottle within the chamber when the bottle is in position within the chamber, such as the bottom 50%, 40%, 30%, 20%, or 10% of the side of the bottle, the top 50%, 40%, 30%, 20%, or 10% of the side of the bottle, the middle of the side of the bottle, or the middle 50%, 40%, 30%, 20%, or 10% of the side of the bottle as measured from the base of the bottle to the top most portion of the bottle within the chamber when the bottle is in position within the chamber.

In embodiments, multiple ultrasonic transducers can be positioned in different places within the chamber.

In embodiments, two ultrasonic transducers are positioned in the chamber. In such an embodiment, both ultrasonic transducers are positioned in one of the positions described above. In embodiments, a first ultrasonic transducer is positioned on or in the bottom wall and a second ultrasonic transducer can be positioned on or in the side wall of the chamber. In embodiments, both ultrasonic transducers are positioned on or in the side wall of the chamber. For example, the two ultrasonic transducers can be positioned on opposite sides of the chamber side wall, such that the two transducers are on opposite sides of a bottle when the bottle is in position within the chamber. For example, the two ultrasonic transducers can be positioned at the same height or different heights of the side wall or of the side of the bottle, as described above. In one example, two ultrasonic transducers are positioned on opposite sides of the chamber side wall, with both positioned in the bottom, middle, or top portion of the side wall based on height of the side wall as measured by the height of the side wall from the end of the chamber opposite to the opening (e.g., bottom wall of the chamber) to the opening.

In embodiments, three ultrasonic transducers are positioned in the chamber. In such an embodiment, all three ultrasonic transducers are positioned in one of the positions described above. In such an embodiment, the three ultrasonic transducers can be positioned in the chamber with all three positioned on or in the bottom wall, all three positioned on or in the side wall, or one or two positioned on or in the bottom wall and the other two or one positioned on or in the side wall. In embodiments, one ultrasonic transducer is positioned on or in the bottom wall and two are positioned on or in the side wall, as described above with respect to two transducers. In embodiments, all three ultrasonic transducers are positioned on or in the side wall of the chamber. For example, the three ultrasonic transducers can be positioned around the perimeter or circumference of the side wall such that there is equal distance between every two transducers of the three transducers. For example, the three ultrasonic transducers can be positioned at the same height, or two of the three transducers can be positioned at the same height, or each transducer can be positioned at a different height of the side wall or of the side of the bottle, as described above. In one example, there are three ultrasonic transducers are positioned within the chamber, with one positioned along every third of the perimeter or circumference of the chamber side wall, with all three positioned in the bottom, middle, or top portion of the side wall based on height of the side wall as measured by the height of the side wall from the end of the chamber opposite to the opening (e.g., bottom wall of the chamber) to the opening.

In embodiments, four ultrasonic transducers are positioned in the chamber. In such an embodiment, all four ultrasonic transducers are positioned in one of the positions described above. In such an embodiment, the four ultrasonic transducers can be positioned in the chamber with all four positioned on or in the bottom wall, all four positioned on or in the side wall, or one, two, or three positioned on or in the bottom wall and the other three, two, or one positioned on or in the side wall. In embodiments, two ultrasonic transducers are positioned on or in the bottom wall and two are positioned on or in the side wall, as described above with respect to two transducers. In embodiments, one ultrasonic transducer is positioned on or in the bottom wall and three are positioned on or in the side wall, as described above with respect to three transducers. In embodiments, all four ultrasonic transducers are positioned in the side wall. For example, the four ultrasonic transducers can be positioned around the perimeter or circumference of the side wall such that there is equal distance between every two transducers of the four transducers. For example, the chamber side wall can comprise four sides, and the four transducers can be positioned on four corners or four sides of the chamber side wall, such that each transducer is positioned opposite from another transducer on the opposite side of the side wall. For example, the four ultrasonic transducers can be positioned at the same height, or the two pairs of transducers can each be positioned at two different heights, or three of the four transducers can be positioned at the same height, or two of the four transducers can be positioned at the same height, or each transducer can be positioned at a different height of the side wall or of the side of the bottle, as described above. In one example, there are four ultrasonic transducers, one positioned along every fourth of the perimeter or circumference of the chamber side wall, with all four positioned in the bottom, middle, or top portion of the side wall based on height of the side wall as measured by the height of the side wall from the end of the chamber opposite to the opening (e.g., bottom wall of the chamber) to the opening. In one example, there are four ultrasonic transducers, one positioned along every fourth of the perimeter or circumference of the chamber side wall, with a first pair positioned in the bottom, middle, or top portion of the side wall based on height of the side wall as measured by the height of the side wall from the end of the chamber opposite to the opening (e.g., bottom wall of the chamber) to the opening, and the second pair positioned in the bottom, middle, or top but not in the same height portion as the first pair.

An ultrasonic transducer can be directed at the bottle at a specified angle, such that the transducer directs ultrasonic energy at and to the bottle at an angle. Directionality of one or more ultrasonic transducers provides for improved heating time and efficiency.

In embodiments, the angle can be measured relative to a plane that is perpendicular to a linear axis extending through the center of the bottle from the center of the base of the bottle to the center of the top of the bottle, with the angle opening toward the center axis of the bottle (except for a transducer that is positioned on that axis, in which case the angle is necessarily measured as an angle opening outward from that axis) and opening in the direction of the top of the bottle (e.g., upward) as opposed to the bottom of the bottle (e.g., downward).

In other words, an angle of zero degrees is directed toward the center axis of the bottle, and the angle is positive in the direction of the top of the bottle (or the direction from which the bottle was inserted into the chamber) and negative in the direction of the bottom of the bottle (or the direction in which the bottle was inserted into the chamber). Note that this description of positive and negative angles relates only to the direction of the transducer relative to a plane perpendicular to the center axis of the bottle, not which part of the bottle is actually targeted by the transducer, as the part of the bottle that is targeted by a transducer depends not only on the angle of the transducer but also on the position of the transducer relative to the bottle, as a transducer with a positive angle may be directed to the base of the bottle if the transducer is positioned below the base of the bottle.

For example, where a bottle is shaped like a cylinder, for a transducer positioned somewhere in the chamber other than directly below the center of the bottle (i.e., a transducer not on the bottle's center axis), an angle of zero degrees means that the transducer is directed toward the bottle's center axis in a direction that is perpendicular to both that center axis and the side of the bottle/cylinder. For example, where a bottle is shaped like a cylinder, an angle of 90 degrees (regardless of whether the transducer is positioned on the bottle's center axis) means that the transducer is directed toward the top of the bottle in a direction that is parallel to the bottle's center axis and perpendicular to the base of the bottle/cylinder. For example, where a bottle is shaped like a cylinder, for a transducer positioned somewhere in the chamber other than directly below the center of the bottle (i.e., a transducer not on the bottle's center axis), an angle of 30 degrees means that the transducer is in the direction of the bottle's center axis and the top of the bottle, in a direction that is 30 degrees from being directed perpendicular to both the bottle's center axis and the side of the bottle/cylinder and is 60 degrees from being directed upward and perpendicular to the base of the bottle/cylinder. For example, where a bottle is shaped like a cylinder, for a transducer positioned somewhere in the chamber other than directly below the center of the bottle (i.e., a transducer not on the bottle's center axis), an angle of −30 degrees (aka 330 degrees) means that the transducer is in the direction of the bottle's center axis and the base of the bottle, in a direction that is 30 degrees from being directed perpendicular to both the bottle's center axis and the side of the bottle/cylinder and is 120 degrees from being directed upward and perpendicular to the base of the bottle/cylinder. For example, where a bottle is shaped like a cylinder, for a transducer positioned somewhere in the chamber other than directly below the center of the bottle (i.e., a transducer not on the bottle's center axis), an angle of 120 degrees means that the transducer is in the direction away from the bottle's center axis and toward the top of the bottle, in a direction that is 120 degrees from being directed perpendicular to and toward the bottle's center axis and is 30 degrees from being directed upward and perpendicular to the base of the bottle/cylinder.

The center axis of the bottle can be parallel to the linear direction in which the bottle is received in the chamber.

In embodiments, an ultrasonic transducer positioned on a side wall of the chamber can be directed at a side a bottle, when the bottle is in position within the chamber, at an angle of about −75, −70, −65, −60, −55, −50, −45, −40, −35, −30, −25, −20, −15, −10, −5, 0, 5, 10, 15, 20, 25, 30, 35, 40, 45, 50, 55, 60, 65, 70, or 75 degrees. For example, this angle can preferably be 35 or −35 degrees or a range of 35 or −35 degrees plus/minus 1, 2, 3, 4, 5, 6, 7, 8, 9, 10, 12.5, 15, 17.5, 20, 22.5, 25, 27.5, 30, or 35 degrees.

In embodiments, an ultrasonic transducer positioned on a side wall or bottom wall of the chamber can be directed at a bottom edge or corner of a bottle, when the bottle is in position within the chamber, at an angle of about −45, −40, −35, −30, −25, −20, −15, −10, −5, 0, 5, 10, 15, 20, 25, 30, 35, 40, 45, 50, 55, 60, 65, 70, 75, 80, 85, or 90 degrees. For example, this angle can preferably be 35 degrees or a range of 35 degrees plus/minus 1, 2, 3, 4, 5, 6, 7, 8, 9, 10, 12.5, 15, 17.5, 20, 22.5, 25, 27.5, 30, or 35 degrees.

In embodiments, an ultrasonic transducer positioned on a side wall or bottom wall of the chamber can be directed at the base of a bottle, when the bottle is in position within the chamber, at an angle of about 10, 15, 20, 25, 30, 35, 40, 45, 50, 55, 60, 65, 70, 75, 80, 85, 90, 95, 100, 105, 110, or 115 degrees. For example, this angle can preferably be 55 degrees or a range of 55 degrees plus/minus 1, 2, 3, 4, 5, 6, 7, 8, 9, 10, 12.5, 15, 17.5, 20, 22.5, 25, 27.5, 30, or 35 degrees.

As shown in FIG. 5, housing 2 comprises first ultrasonic transducer 70 and second ultrasonic transducer 80, both positioned in the bottom portion 50 of chamber 40. First and second ultrasonic transducers 70, 80 are both positioned near the base of interior wall 42. First and second ultrasonic transducers 70, 80 are positioned on second side 44 and fourth side 46, respectively, of interior wall 42, such that first and second ultrasonic transducers 70, 80 are positioned on opposite sides of chamber 40. First ultrasonic transducer 70 is directed at bottle 100 in a first direction 72, which is at a first angle θ₁ relative to a horizontal plane, i.e., a plane that is perpendicular to the center of axis 150 of bottle 100 when bottle 100 is in position within chamber 40. Second ultrasonic transducer 80 is directed at bottle 100 in a second direction 82, which is at a second angle θ₂ relative to that same horizontal plane. The first and second angles θ₁, θ₂ can be the same or different. For example, the first and second angles θ₁, θ₂ can both be 35 degrees or 35 degrees plus/minus 1, 2, 3, 5, 7, 10, or 15 degrees.

The first and second directions 72, 82 are each directed from the bottom and side of chamber 40 toward the center axis 150 of bottle 100, at angles θ₁ and θ₂, respectively, such that first and second ultrasonic transducers 70, 80 direct ultrasonic energy at the base 120, the bottom of enclosed portion 132 of side 130, and the bottom edge of bottle 100. First and second ultrasonic transducers 70, 80 are directed at opposite sides of bottle 100 based on their respective positioning and based on first direction 72 and second direction 82, respectively. As shown in FIG. 5, first and second ultrasonic transducers 70, 80 are proximate to but not in physical contact with bottle 100 with bottle 100 in position within chamber 40. In other embodiments, first ultrasonic transducer 70 and/or second ultrasonic transducer 80 are or can be in physical contact with bottle 100 when bottle 100 is in position within chamber 40.

In embodiments, bottle 100 is heated at a given time by heating plate 60, first ultrasonic transducer 70, and/or second ultrasonic transducer 80. In embodiments, bottle 100 is first heated by heating plate 60 along with first and second ultrasonic transducers 70, 80 and then heated only by heating plate 60 or one or both of first and second ultrasonic transducers 70, 80, for example, once a target temperature of the contents of the bottle is reached, such as to maintain the contents at the target temperature.

In embodiments, the positioning and angling of one or more ultrasonic transducers and/or one or more heating elements within the chamber can be adjustable, such that it or they can be manually adjusted or automatically adjusted. Such adjustment can be based on, for example, bottle size or shape, heating profile, or various settings.

In embodiments, the apparatus comprises temperature detection and related components. In embodiments, the apparatus comprises one or more integrated infrared (IR) temperature sensors. The infrared temperature sensor can, for example, be positioned within the chamber, such as in or on a bottom wall or side wall of the chamber.

The infrared temperature sensor can, for example, be directed to sensing (or detecting, measuring, or reading) the temperature of a substance within the bottle. Such use of an infrared temperature sensor provides for more accurately detecting the temperature of the contents of the bottle as opposed to sensing the temperature of a heating bath in which the bottle is placed.

As shown in FIG. 7, housing 2 comprises an infrared temperature sensor 90 positioned in chamber 40. Infrared temperature sensor 90 is positioned at the top of the third side 45 of interior wall 42 of chamber 40. Infrared temperature sensor 90 is configured and directed to sense the temperature of contents within the bottle interior 140 of bottle 100, as exemplified by the dashed arrow from infrared temperature sensor 90 in FIG. 7.

In embodiments, multiple infrared temperature sensors are utilized for sensing temperature of the bottle contents at multiple locations within the bottle, such as a first infrared temperature sensor positioned to detect the temperature of contents in a first location of the bottle and a second infrared temperature sensor positioned to detect the temperature of contents in a second location of the bottle. For example, the first and second locations for sensing temperature can be (i) a location proximate to or targeted by one or more heating elements or transducers and (ii) a location not proximate to or targeted by one or more heating elements or transducers, or can be locations in the (i) bottom of the bottle and (ii) middle or top of the bottle. The apparatus can, for example, analyze the two or more signals from two or more infrared temperature sensors to calculate the average temperature of the bottle contents.

In embodiments, the apparatus can comprise programming and related components. For example, the apparatus can comprise a processor or controller, which can send and receive signals to, and control, the operational components described herein. In one example, the apparatus can calculate optimal heating time and/or remaining heating time based on, for example, one or more detected temperature measurements (e.g., temperature signals received from IR temperature sensor), heating capacity of the apparatus or the heating components of the apparatus, the type or amount of contents to be heated (e.g., based on weight or volume), and/or system settings. Heating capacity, for example, can relate to the rate at which the apparatus or its heating component(s) can heat the contents of a bottle. In one example, the apparatus can detect when a heating or thawing action is complete by comparing one or more detected temperature measurements (e.g., temperature signals received from IR temperature sensor) to a target temperature. For example, upon detection that a heating or thawing action is compete or near completion, the apparatus can stop operation of the heating components or reduce their operation (e.g., reduce intensity of heating components or reduce the number of heating components in operation).

In embodiments, the apparatus can utilize variable system settings for selecting, for example: target temperature to which contents of the bottle is heated; time for heating the contents of the bottle; heating liquid contents versus thawing frozen contents of the bottle; number of bottles for heating/thawing with the apparatus at one time; and/or an indicator to indicate that an action is complete (e.g., thawing or heating to target temperature or time). For example, an indicator can be an indicator sound emitted by the apparatus, an indicator signal displayed by the apparatus, or an indicator notification transmitted to a user's personal device (e.g., phone), such as a text message, email, or push notification.

In embodiments, the apparatus can comprise a control panel or other control mechanism, display, or device for operating or controlling the system or its programming or settings. The control panel, for example, can be on the exterior of the housing.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated.

1. A bottle heating apparatus comprising:
a housing comprising a chamber for receiving a bottle;
at least one ultrasonic transducer disposed within the chamber and configured to heat a substance within the bottle with an ultrasonic energy when the bottle is positioned in the chamber, wherein said at least one ultrasonic transducer is positioned to direct the ultrasonic energy toward a center axis of the bottle at an angle relative to a plane perpendicular to the center axis of the bottle when the bottle is positioned in the chamber, wherein the angle is between 10 and 60 degrees, the angle being defined as positive in a direction from which the bottle is received by the chamber.

2. The bottle heating apparatus of claim 1, wherein the angle is between 20 and 50 degrees.

3. The bottle heating apparatus of claim 1, wherein the angle is between 30 and 40 degrees.

4. The bottle heating apparatus of claim 1, wherein the ultrasonic transducer is positioned within the chamber to direct the ultrasonic energy at a side of the bottle when the bottle is positioned in the chamber.

5. The bottle heating apparatus of claim 1, wherein the ultrasonic transducer is positioned within the chamber to direct the ultrasonic energy at a base of the bottle when the bottle is positioned in the chamber.

6. The bottle heating apparatus of claim 1, further comprising a non-ultrasonic heating element configured to heat the substance within the bottle when the bottle is positioned in the chamber.

7. The bottle heating apparatus of claim 6, wherein a base of the bottle rests on the non-ultrasonic heating element when the bottle is positioned in the chamber.

8. The bottle heating apparatus of claim 1, further comprising an infrared temperature sensor configured to detect the temperature of the substance within the bottle.

9. The bottle heating apparatus of claim 8, further comprising a programming component configured to calculate an optimal heating time based on a detected temperature measurement of the substance within the bottle and a heating capacity of the apparatus, wherein the detected temperature measurement is detected by the infrared temperature sensor.

10. The bottle heating apparatus of claim 1, wherein the substance within the bottle is heated by the ultrasonic transducer without use of a liquid bath.

11. A bottle heating apparatus comprising:
a housing comprising a chamber for receiving a bottle;
at least a first ultrasonic transducer and a second ultrasonic transducer both disposed within the chamber and configured to heat a substance within the bottle with a first ultrasonic energy and second ultrasonic energy, respectively, when the bottle is positioned in the chamber, wherein the first ultrasonic transducer and the second ultrasonic transducer are positioned to direct the first ultrasonic energy and second ultrasonic energy, respectively, toward a center axis of the bottle at a first angle and a second angle, respectively, relative to a plane perpendicular to the center axis of the bottle when the bottle is positioned in the chamber, wherein the first angle and the second angle are each between 10 and 60 degrees, the first angle and the second angle being defined as positive in a direction from which the bottle is received by the chamber.

12. The bottle heating apparatus of claim 11, wherein the first angle and the second angle are each between 20 and 50 degrees.

13. The bottle heating apparatus of claim 11, wherein the first angle and the second angle are each between 30 and 40 degrees.

14. The bottle heating apparatus of claim 11, wherein the first ultrasonic transducer and the second ultrasonic transducer are positioned on opposite sides of the chamber.

15. The bottle heating apparatus of claim 11, wherein the first ultrasonic transducer and the second ultrasonic transducer are positioned within the chamber to direct the first ultrasonic energy and second ultrasonic energy, respectively, at a side of the bottle when the bottle is positioned in the chamber.

16. The bottle heating apparatus of claim 11, wherein the first ultrasonic transducer and the second ultrasonic transducer are positioned within the chamber to direct the first ultrasonic energy and second ultrasonic energy, respectively, at a base of the bottle when the bottle is positioned in the chamber.

17. The bottle heating apparatus of claim 11, further comprising a non-ultrasonic heating element configured to heat the substance within the bottle when the bottle is positioned in the chamber.

18. The bottle heating apparatus of claim 17, wherein a base of the bottle rests on the non-ultrasonic heating element when the bottle is positioned in the chamber.

19. The bottle heating apparatus of claim 11, further comprising an infrared temperature sensor configured to detect the temperature of the substance within the bottle.

20. The bottle heating apparatus of claim 19, further comprising a programming component configured to calculate an optimal heating time based on a detected temperature measurement of the substance within the bottle and a heating capacity of the apparatus, wherein the detected temperature measurement is detected by the infrared temperature sensor.

21. The bottle heating apparatus of claim 11, wherein the substance within the bottle is heated by the first ultrasonic transducer and the second ultrasonic transducer without use of a liquid bath.
